(19) United States
(12) Patent Application Publication
(10) Pub. No.: US 2026/0225150 A1
(43) Pub. Date: Aug. 6, 2026

(54) METHOD FOR FORMING A FACE SPLINE IN A CONSTANT VELOCITY JOINT

(71) Applicant: HANSAE MOBILITY CO., LTD., Daegu (KR)

(72) Inventors: Dal Soo JANG, Daegu (KR); Hyun Woo LEE, Daegu (KR)

(73) Assignee: HANSAE MOBILITY CO., LTD., Daegu (KR)

(21) Appl. No.: 19/153,037

(22) PCT Filed: Jan. 8, 2024
(86) PCT No.: PCT/KR2024/000326

§ 371 Date: Aug. 1, 2025

(30) Foreign Application Priority Data
Feb. 6, 2023 (KR) 10-2023-0015745

(51) Int. Cl. B21K 1/76

(52) U.S. Cl. CPC B21K 1/762

(57) ABSTRACT

The method for forming a face spline in a constant velocity joint includes forming a preliminary face spline on a base material through hot forging to produce an intermediate formed product, and additionally forming the preliminary face spline into the face spline through cold forging. The preliminary face spline has a tooth profile including inclined side surfaces and a bottom located between the inclined side surfaces, and during the cold forging process, pressure is applied to the inclined side surfaces so that the material flows toward the bottom.

### TECHNICAL FIELD

The present invention relates to a method for forming a face spline in a constant velocity joint, which is an element for transmitting driving force in an automobile.

### BACKGROUND ART

A constant velocity joint, which is a power transmission component, is a part of the drivetrain that transmits driving force generated by a vehicle's power source, such as an internal combustion engine or an electric motor, to the wheels. As is well known, a constant velocity joint is configured to transmit rotational driving force while accommodating displacement in various directions that occurs during vehicle operation, and it can be implemented in various forms, such as a Rzeppa joint.

A constant velocity joint may be connected to a wheel hub to allow transmission of driving power to the wheel, and the constant velocity joint and the wheel hub are typically connected via a spline structure so as to rotate together.

While it is common to connect a constant velocity joint and a wheel hub to each other via splines formed to extend in the axial direction of the constant velocity joint, a technique has recently been introduced in which the constant velocity joint and the wheel hub are dynamically connected via so-called face splines formed on a surface perpendicular to the axial direction of the constant velocity joint. In the face spline-based connection method, the constant velocity joint and the wheel hub are coupled to rotate together through respective face splines formed on the facing surfaces thereof.

Various methods for forming face splines on a constant velocity joint or a wheel hub have been proposed. For example, Korean Patent Nos. 10-1960098 and 10-2001883 disclose a method of forming front teeth, i.e., face splines, through plastic deformation caused by the pressing of a knife. Korean Patent Nos. 10-1573023 and 10-1696907 disclose a method in which a preliminary wheel hub is formed through a hot forging process, and face splines are subsequently formed through a cold forging process. The conventional methods for manufacturing face splines have room for improvement in terms of product quality and manufacturing efficiency, and there is a need for an efficient manufacturing method capable of ensuring the mechanical quality of face splines while enabling low-cost mass production.

### PRIOR ART DOCUMENTS

Korean Patent No. 10-1960098 (Registration Date: Mar. 13, 2019)
Korean Patent No. 10-2001883 (Registration Date: Jul. 15, 2019)
Korean Patent No. 10-1573923 (Registration Date: Nov. 24, 2015)
Korean Patent No. 10-1696907 (Registration Date: Jan. 10, 2017)

### DETAILED DESCRIPTION OF THE INVENTION

### Technical Problem

An object of the present invention is to provide a method for forming a face spline that allows for low-cost mass production while securing the mechanical quality of the face spline.

### Technical Solutions

According to an embodiment of the present invention, a method for forming a face spline in a constant velocity joint includes: forming an intermediate formed product by forming a preliminary face spline on a base material through hot forging; and additionally forming the preliminary face spline into the face spline through cold forging. The preliminary face spline has a tooth profile including inclined side surfaces and a bottom located between the inclined side surfaces, and during the cold forging, pressure is applied to the inclined side surfaces of the preliminary face spline so that material flows toward the bottom, thereby forming the face spline.

The bottom of the preliminary face spline may be configured not to contact the cold forging die during the cold forging process.

The hot forging may be performed using a hot forging die including an upper die and a lower die, and the lower die comprises a detachable tooth-forming portion for forming the preliminary face spline.

The hot forging may be performed using a hot forging die, and the hot forging die may include a cooling system for cooling.

The cold forging may be performed using a cold forging die and a cold forging punch configured to apply a pressing force to the intermediate formed product placed on the cold forging die. In this regard, the cold forging punch may include a front end surface and an inclined surface formed near the front end surface.

The inclined surface may be provided at a position corresponding to the preliminary face spline during the cold forging process, and the inclined surface may have an angle of 40 degrees or less.

The inclined surface may be provided at a position corresponding to the preliminary face spline during the cold forging process, and the intermediate formed product may include an open space into which the cold forging punch is inserted during the cold forging process. The open space may form a bottom surface and an inclined surface surrounding the bottom surface, and the inclined surface of the cold forging punch may be configured to have an angle less than or equal to that of the inclined surface of the open space.

The front end surface of the cold forging punch may be configured not to contact the bottom surface of the open space during the cold forging process.

The cold forging may be performed such that the amount of deformation of the tooth profile of the preliminary face spline is 4% to 20% of a tooth width.

The method may further include performing a lubrication coating process on the intermediate formed product, and the lubrication coating may be locally applied to the preliminary face spline during the lubrication coating process.

A constant velocity joint according to an embodiment of the present invention may include a face spline formed by any of the methods according to the embodiments of the present invention described above.

### Effect of the Invention

According to the present invention, it is possible to form a face spline that ensures mechanical quality while enabling low-cost mass production.

### BRIEF DESCRIPTION OF THE DRAWINGS

FIG. 1 is a view showing a constant velocity joint provided with a face spline formed by a method for forming a face spline according to an embodiment of the present invention.

FIG. 2 is a view showing the CV joint of FIG. 1 in a state coupled with a wheel hub.

FIG. 3 is a schematic flowchart illustrating a method for forming a face spline according to an embodiment of the present invention.

FIG. 4 is a view showing a hot forging die for performing a hot forging process in a method for forming a face spline according to an embodiment of the present invention.

FIG. 5 is a view showing a cooling system of the hot forging die for performing the hot forging process in a method for forming a face spline according to an embodiment of the present invention.

FIG. 6 is a view sequentially illustrating each step of a hot forging process in a method for forming a face spline according to an embodiment of the present invention.

FIG. 7 is a view showing a die, an intermediate formed product, and a cold forging punch for performing a cold forging process in a method for forming a face spline according to an embodiment of the present invention.

FIG. 8 is a view illustrating a cold forging process in a method for forming a face spline according to an embodiment of the present invention.

FIG. 9 is a view showing an intermediate workpiece obtained through a hot forging process and a punch for performing a cold forging process in a method for forming a face spline according to an embodiment of the present invention.

FIG. 10 is a view illustrating a shape change of the intermediate workpiece caused by a cold forging process in a method for forming a face spline according to an embodiment of the present invention.

### BEST MODE FOR CARRYING OUT THE INVENTION

Hereinafter, embodiments of the present invention will be described in detail with reference to the accompanying drawings.

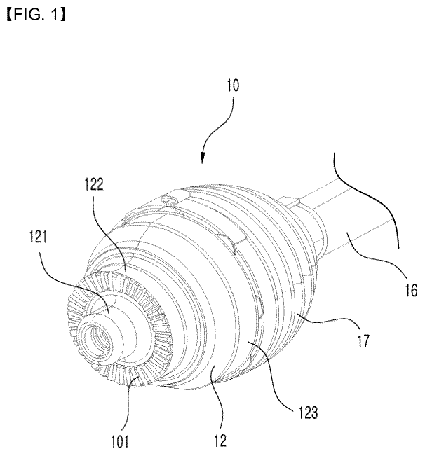

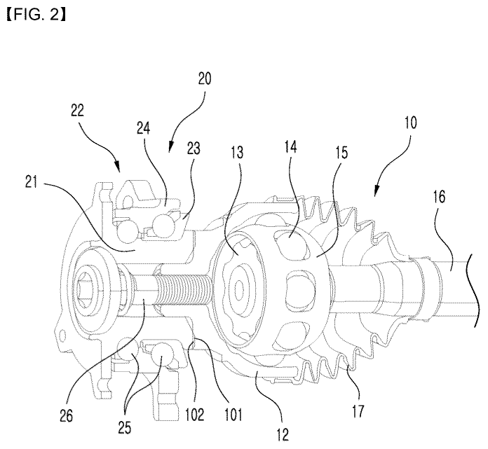

Referring to FIGS. 1 and 2, a constant velocity joint 10 to which a method according to an embodiment of the present invention can be applied may be in the form of a so-called Rzeppa joint, and may include an outer joint member 12, an inner joint member 13 disposed within the outer joint member 12, a plurality of power transmission balls 14 arranged to transmit rotational power between the outer joint member 12 and the inner joint member 13, and a ball cage 15 that accommodates the plurality of power transmission balls 14. The power transmission balls 14 may be disposed in ball grooves respectively formed in the outer joint member 12 and the inner joint member 13 so as to transmit rotational power from the inner joint member 13 to the outer joint member 12. A drive shaft 16 is coupled to the inner joint member 13 so as to rotate together with it. The outer joint member 12 may have a cup shape with a U-shaped cross-section open at one side, and a boot 17 may be coupled to the open end of the outer joint member 12 and the drive shaft 16, respectively. Since the components and operating principles of such a constant velocity joint are well known to those skilled in the art, a detailed description thereof will be omitted.

For example, a wheel bearing 20 may include a wheel hub 21 and rolling bearings 22. The wheel hub 21 has a generally cylindrical shape, and the rolling bearings 22 rotatably support the wheel hub 21. The rolling bearings 22 may include an inner race 23 fitted and secured to the outer circumferential surface of the wheel hub 21 in the axial direction; an outer race 24, which is positioned radially outward of the inner race 23 and is fixedly coupled to a stationary component of the vehicle, such as a vehicle body or a knuckle; and ball-shaped rolling elements 25 interposed between the inner race 23 and the outer race 24 or between the wheel hub 21 and the outer race 24. As illustrated in FIG. 2, a plurality of the rolling elements 25 may be arranged in two rows.

A fastening bolt 26 axially fastens the wheel hub 21 and the outer joint member 12 to each other. The outer joint member 12 may include a shaft portion 121, a shoulder portion 122, and a mouth portion 123, and a fastening bolt 26 may be fastened to the shaft portion 121. Meanwhile, the wheel hub 21 and the outer joint member 12 are respectively provided with face splines 101 and 102, and are coupled to rotate together through the engagement of the face splines 101 and 102.

The face spline 101 of the outer joint member 12 may be formed on the outer circumferential surface of the shoulder portion 122 so as to face the wheel hub 21. The face spline 102 of the wheel hub 21 is formed on a surface facing the face spline 101 of the outer joint member 12. When the outer joint member 12 and the wheel hub 21 are coupled in a state where they are rotationally constrained via the face splines 101 and 102, rotation of the outer joint member 12 causes the wheel hub 21 to rotate. Accordingly, the rotational driving force of the constant velocity joint 10 can be transmitted to the wheel hub 21.

The method for forming a face spline according to an embodiment of the present invention may be used to form the face spline 101 of the outer joint member 12 of the constant velocity joint 10 described above. Hereinafter, a method for forming the face spline 101 on the outer joint member 12 will be described in detail.

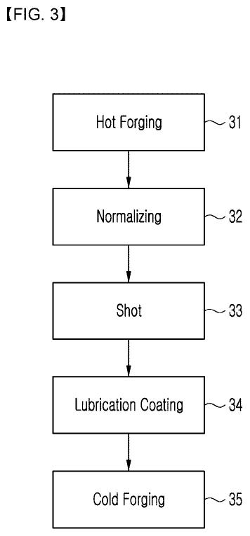

FIG. 3 is a flowchart schematically illustrating a process for forming a face spline according to an embodiment of the present invention. Referring to FIG. 3, the method for forming a face spline according to the present embodiment may include a hot forging process 31, a normalizing process 32, a shot process 33, a lubrication coating process 34, and a cold forging process 35. Hereinafter, each of these processes will be described in sequence.

### Hot Forging Process (31)

In the hot forging process, a metal base material is heated and subjected to forging at a high temperature. Through the hot forging process, the outer joint member and a preliminary shape of the face spline are primarily formed.

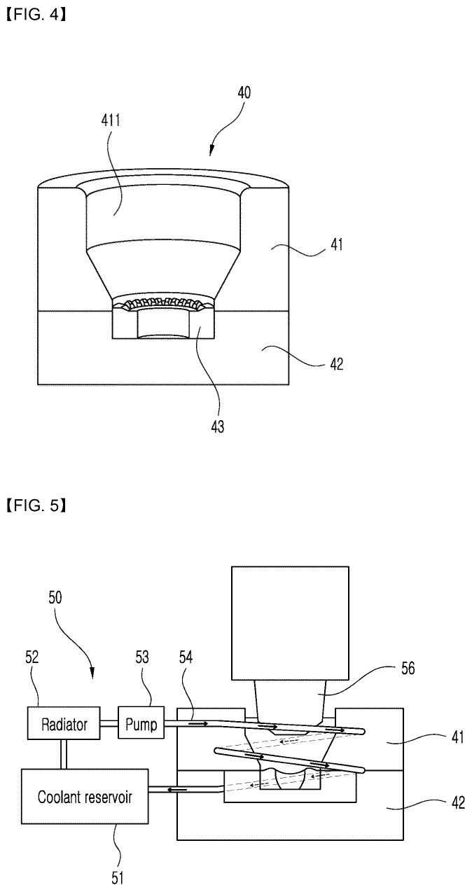

FIG. 4 illustrates a die for performing the hot forging process. Referring to FIG. 4, a hot forging die 40 for performing the hot forging process is formed by separating an upper die 41 and a lower die 42. The upper die 41 may be provided with a forming cavity 411 corresponding to the outer shape of the outer joint member. In a state where the base material is inserted into the forming cavity 411, forging may be performed by a forging punch. A tooth-forming portion 43 for forming the face spline 101 is configured to be detachable from the lower die 42. That is, by allowing only the tooth-forming portion 43, which is subject to severe wear due to repeated forging processes, to be replaceable, the cost of the forging die can be reduced.

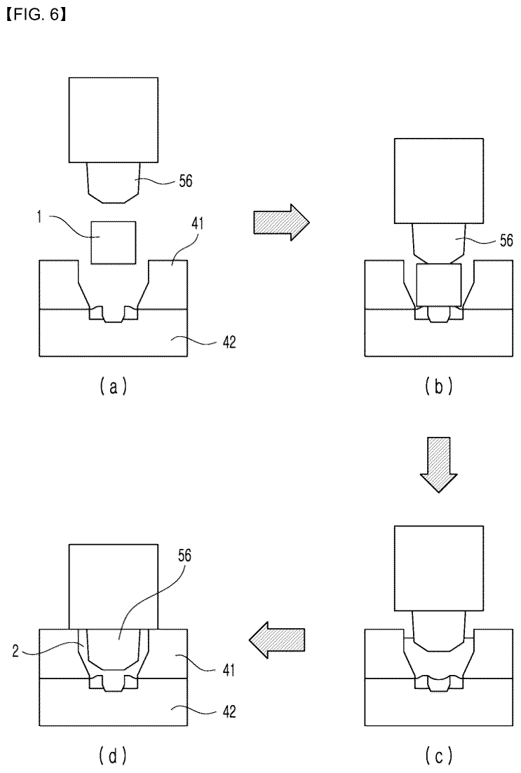

FIG. 5 illustrates an example in which a cooling system is applied to a die for performing the hot forging process. Referring to FIG. 5, by applying a cooling system 50 to the die during the hot forging process performed at high temperatures, it is possible to prevent rapid wear of the die under high-temperature conditions, thereby extending the service life of the die.

For example, the cooling system 50 may include a coolant reservoir 51 for storing coolant, a radiator 52 configured to perform heat exchange for cooling the coolant, a pump 53 for circulating the coolant, and a coolant circulation line 54 through which the coolant circulates. The coolant circulation line 54 is configured to form a circulation path passing through the coolant reservoir 51, the radiator 52, the pump 53, and the die 40. Accordingly, the die can be cooled during and/or after the hot forging performed by a forging punch 56, thereby extending the service life of the die.

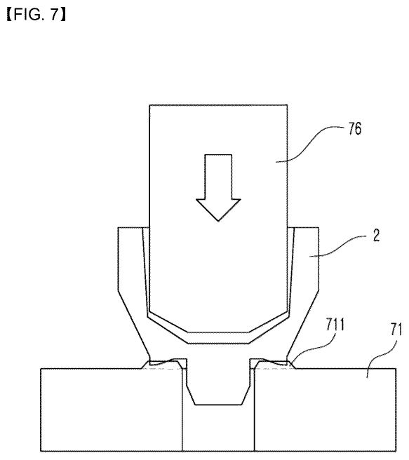

FIG. 6 illustrates the hot forging process, and (a), (b), (c), (d) sequentially show the main steps of the hot forging process. In a state where the upper die 41 and the lower die 42 are mated, plastic deformation of the base material 1 is performed by the action of the forging punch 56, thereby obtaining an intermediate formed product 2. As described above, the hot forging die 40 includes a tooth-forming portion for forming the face spline, and thus, the intermediate formed product 2 includes a preliminarily processed face spline 4.

### Normalizing Process 32

Normalizing is a heat treatment process following the forging, performed to improve toughness and mechanical properties. The normalizing process may be carried out by heating the formed product obtained through the hot forging process to a predetermined temperature, and then air cooling it in the atmosphere. Through the normalizing process, residual stress inside the forged product can be relieved, and coarse grains can be refined into finer grains.

### Shot Process 33

The shot process is a surface treatment process for cleaning and finishing the surface of the formed product. For example, the shot process may be performed by shot blasting to treat the surface of the formed product obtained through the hot forging process.

### Lubrication Coating Process 34

The lubrication coating process is a process of forming a lubricating film on the surface of the intermediate formed product prior to the cold forging process 35. In the embodiment of the present invention, in order to reduce processing time and cost, the lubrication coating may be locally applied only to the portion where the face spline is to be formed, i.e., the preliminary face spline 4.

### Cold Forging Process 35

After the normalizing process, the shot process, and the lubrication coating process are performed on the formed product obtained through the hot forging process, a cold forging process 35 is performed on the resulting intermediate formed product 2.

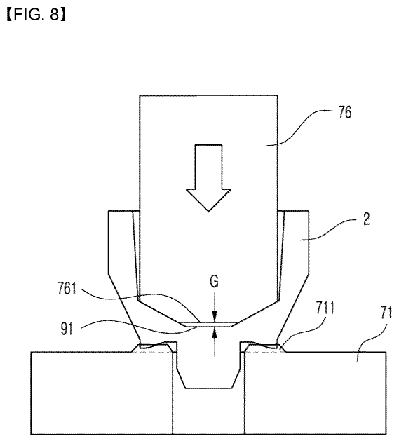

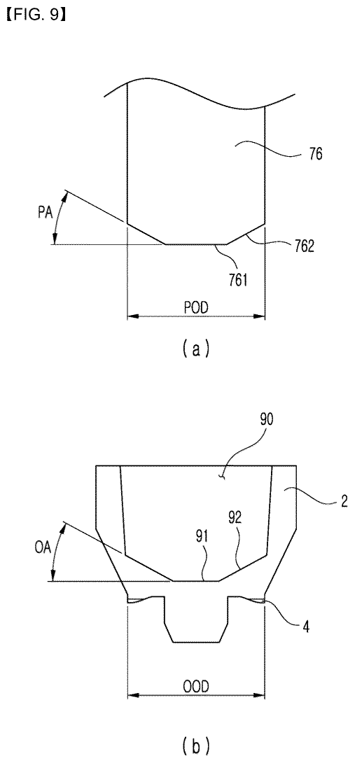

FIG. 7 is a view showing a die, an intermediate formed product, and a cold forging punch for performing the cold forging process in the method for forming a face spline according to an embodiment of the present invention, and FIG. 8 is a view illustrating the cold forging process according to the embodiment of the present invention. FIG. 7 shows a state before the cold forging punch 71 comes into contact with the intermediate formed product 2, and FIG. 8 shows a state in which deformation of the intermediate formed product 2 has occurred due to the action of the cold forging punch 71.

Referring to FIG. 7, a cold forging die 71 for the cold forging process is provided with a tooth-forming portion 711 for forming the face spline 101. In a state where the intermediate formed product 2 is placed on the cold forging die 71, cold forging may be performed by a cold forging punch 76 moving in the direction of the arrow to press the intermediate formed product 2. FIG. 8 shows a state in which the cold forging punch 76 has moved in the direction of the arrow and is in close contact with the intermediate formed product 2. In this process, material flow is generated by the pressing force of the cold forging punch 76, and the face spline 301 is formed by the tooth-forming portion 711 of the cold forging die 71.

In the embodiment of the present invention, the shapes of the cold forging punch 76 and the intermediate formed product 2, which is the subject of the cold forging, are optimized in order to improve cold forgeability.

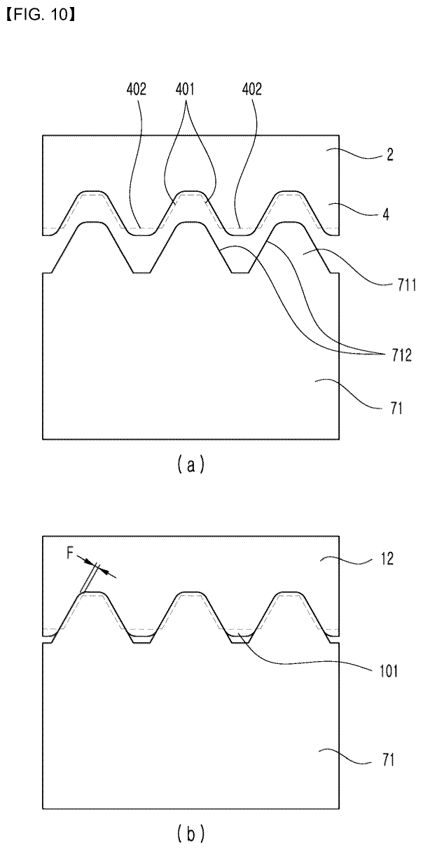

In FIG. 9(a), the cold forging punch 76 is illustrated, and in FIG. 9(b), a cross-sectional view of the intermediate formed product 2 to be subjected to cold forging is shown. The intermediate formed product 2 has a shape formed by the hot forging process described above and includes an open space 3 into which the cold forging punch 76 is inserted, and a preliminary face spline 4. The preliminary face spline 4 is finally formed into the face spline 101 described above through the cold forging process.

The cold forging punch 76 includes a front end surface 761 and an inclined surface 762 formed near the front end surface 761. For example, the inclined surface 762 may be formed to surround the front end surface 761 and may be located approximately at a position corresponding to the preliminary face spline 4. The front end surface 761 may have a generally circular shape, and the inclined surface 762 may have a ring-shape band configuration in which the outer edge is inclined rearward. In this case, the outer diameter POD of the cold forging punch 76 is set to be equal to or greater than the outer diameter OOD of the preliminary face spline 4 (POD≥OOD). Accordingly, pressing force from the cold forging punch 76 can be uniformly applied to the region where the preliminary face spline 4 is formed.

The inclination angle PA of the inclined surface 762 of the cold forging punch 76 is formed to be 40 degrees or less. Accordingly, the pressing force of the cold forging punch 76 can be uniformly applied to the region where the preliminary face spline 4 is formed.

The open space 90 of the intermediate formed product 2 includes a bottom surface 91 and an inclined surface 92 surrounding the bottom surface 91. The bottom surface 91 and the inclined surface 92 of the intermediate formed product 2 are formed at positions approximately corresponding to the front end surface 761 and the inclined surface 762 of the cold forging punch 76, respectively. In this regard, the inclination angle PA of the inclined surface 762 of the cold forging punch 76 is formed to be equal to or less than the inclination angle OA of the inclined surface 92 of the intermediate formed product 2 (PA≤OA). Accordingly, the pressing force of the cold forging punch 76 is not concentrated on the central portion but is evenly distributed across the entire preliminary face spline 4.

Furthermore, as shown in FIG. 8, the front end surface 761 of the cold forging punch 76 is formed so as not to contact the bottom surface 91 of the open space 90 of the intermediate formed product 2 during the forging process. That is, a gap G is maintained between the front end surface 761 of the cold forging punch 76 and the bottom surface 91 of the open space 90 during the forging process. As a result, the quality of the spline can be improved.

FIG. 10 illustrates the forming of spline teeth by the cold forging process. FIG. 10(a) shows a state before cold forging is performed, and FIG. 10(b) shows a state after cold forging is completed. In FIG. 10, the spline teeth before cold forging are indicated by dotted lines, while the spline teeth after cold forging are indicated by solid lines. When the preliminary face spline 4 is placed on the tooth-forming portion 711 of the cold forging die 71 and pressing force is applied by the cold forging punch 76, plastic deformation of the teeth of the preliminary face spline 4 occurs, thereby forming the final face spline 101. The tooth profile of the preliminary face spline 4 includes inclined side surfaces 401 formed to be inclined in opposite directions and a flat bottom surface 402 located between the inclined side surfaces 401. In this regard, the flat bottom surface 402 of the preliminary face spline 4, shown in dotted lines, is formed so as not to contact the bottom of the groove of the tooth-forming portion 711 of the cold forging die 71, and the inclined side surfaces 401 are brought into contact with the inclined side surfaces 712 of the tooth-forming portion 711, so that force is first applied to the inclined side surfaces 401. Accordingly, pressure is applied to the inclined side surfaces 401 of the teeth of the preliminary face spline 4, and the flat bottom surface 402 acts as an opening through which material flow is directed toward the bottom. As a result, the formability of the cold forging process can be improved.

Referring to FIG. 10, the amount of deformation F of the inclined surface of the tooth profile of the preliminary face spline 4 is set to be 4% to 20% of the tooth width. Here, the tooth width refers to the width of the tooth at a mid-height position, that is, the width measured at the midpoint between the peak of the tooth and a line connecting the ends of adjacent grooves. By setting the deformation amount in this manner, improvements in formability and product quality can be achieved.

While the embodiments of the present invention have been described above, the scope of the present invention is not limited thereto, and various modifications and alterations may be made by those skilled in the art without departing from the scope of the invention. Accordingly, all such modifications and equivalents should be construed as being included within the scope of the present invention.

1. A method for forming a face spline in a constant velocity joint, comprising:
forming an intermediate formed product by forming a preliminary face spline on a base material through hot forging; and
additionally forming the preliminary face spline into the face spline through cold forging,
wherein the preliminary face spline has a tooth profile including inclined side surfaces and a bottom located between the inclined side surfaces, and
wherein, during the cold forging, pressure is applied to the inclined side surfaces of the preliminary face spline so that material flows toward the bottom, thereby forming the face spline.

2. The method for forming the face spline of claim 1, wherein the bottom of the preliminary face spline is configured not to contact the cold forging die during the cold forging process.

3. The method for forming the face spline of claim 1, wherein the hot forging is performed using a hot forging die including an upper die and a lower die, and
wherein the lower die comprises a detachable tooth-forming portion for forming the preliminary face spline.

4. The method for forming the face spline of claim 1, wherein the hot forging is performed using a hot forging die, and
wherein the hot forging die comprises a cooling system for cooling.

5. The method for forming the face spline of claim 1, wherein the cold forging is performed using a cold forging die and a cold forging punch configured to apply a pressing force to the intermediate formed product placed on the cold forging die, and
wherein the cold forging punch comprises a front end surface and an inclined surface formed near the front end surface.

6. The method for forming the face spline of claim 5, wherein the inclined surface is provided at a position corresponding to the preliminary face spline during the cold forging process, and
wherein the inclined surface has an angle of 40 degrees or less.

7. The method for forming the face spline of claim 5, wherein the inclined surface is provided at a position corresponding to the preliminary face spline during the cold forging process,
wherein the intermediate formed product comprises an open space into which the cold forging punch is inserted during the cold forging process,
wherein the open space forms a bottom surface and an inclined surface surrounding the bottom surface, and
wherein the inclined surface of the cold forging punch is configured to have an angle less than or equal to that of the inclined surface of the open space.

8. The method for forming the face spline of claim 7, wherein the front end surface of the cold forging punch is configured not to contact the bottom surface of the open space during the cold forging process.

9. The method for forming the face spline of claim 1, wherein the cold forging is performed such that the amount of deformation of the tooth profile of the preliminary face spline is 4% to 20% of a tooth width.

10. The method for forming the face spline of claim 1, further comprising performing a lubrication coating process on the intermediate formed product,
wherein the lubrication coating is locally applied to the preliminary face spline during the lubrication coating process.

11. A constant velocity joint comprising a face spline formed by the method according to claim 1.
